(19) United States
(12) Patent Application Publication
(10) Pub. No.: US 2016/0260548 A1
(43) Pub. Date: Sep. 8, 2016

(54) TANTALUM CAPACITOR

(71) Applicant: SAMSUNG ELECTRO-MECHANICS CO., LTD., Suwon-Si (KR)

(72) Inventors: Hong Kyu SHIN, Suwon-Si (KR); Hyun Sub OH, Suwon-Si (KR); Hyoung Sun HAM, Suwon-Si (KR); Jae Hyuk CHOI, Suwon-Si (KR)

(21) Appl. No.: 14/951,109

(22) Filed: Nov. 24, 2015

(30) Foreign Application Priority Data
Mar. 4, 2015 (KR) 10-2015-0030486

(51) Int. Cl. H01G 9/10; H01G 9/15; H01G 9/042; H01G 9/012; H01G 9/025

(52) U.S. Cl. CPC H01G 9/10; H01G 9/012; H01G 9/025; H01G 9/042; H01G 9/15

(57) ABSTRACT

A tantalum capacitor includes tantalum elements having protruding anode lead wires, a sealing part enclosing the tantalum elements, an insulating member disposed below the sealing part, an anode terminal electrically connected to the anode lead wires, and a cathode terminal electrically connected to the tantalum elements. At least two tantalum elements are connected in parallel, and the cathode terminal includes a cathode terminal part disposed on a lower surface of the insulating member through a plurality of vias penetrating through the insulating member.

### CROSS-REFERENCE TO RELATED APPLICATION

This application claims the priority and benefit of Korean Patent Application No. 10-2015-0030486 filed on Mar. 4, 2015, with the Korean Intellectual Property Office, the disclosure of which is incorporated herein by reference.

### TECHNICAL FIELD

The present disclosure relates to a tantalum capacitor.

### BACKGROUND

A solid electrolytic capacitor is an electronic component used to block direct current and pass alternating current in addition to a function of accumulating electricity.

Among solid electrolytic capacitors, a tantalum capacitor is a miniaturized capacitor, using tantalum as an anode material thereof, such that the tantalum capacitor may have high capacitance and compact size and a stable anodized film may be formed on tantalum. In particular, tantalum capacitors have been mainly used in order to decrease noise in a circuit or portable communication device of which frequency characteristics come into question.

For example, the tantalum capacitor may be composed of a tantalum element formed by sealing and sintering tantalum powder, anode and cathode terminals connected to the tantalum element, and a sealing material sealing the tantalum element. In this case, the tantalum element may be formed by sequentially stacking a tantalum oxide (Ta₂O₅) layer, a solid electrolyte layer formed of manganese dioxide (MnO₂), a conductive carbon layer, and a silver (Ag) layer on a surface thereof.

There is no direct current (DC)-bias direction in a general tantalum capacitor, and such a general tantalum capacitor is not affected by acoustic noise.

Recently, however, with the introduction of premium electronic products such as smartphones, demand for a capacitor capable of being driven at a high frequency has increased, but a general tantalum capacitor does not satisfy this demand.

Therefore, in order to implement a tantalum capacitor suitable for a high frequency band, it is required that equivalent series inductance (ESL) of the tantalum capacitor be decreased.

Thus, a solution to a problem of existing tantalum capacitors that may not be driven in a high frequency band due to high ESR characteristics and high ESL characteristics caused by the high ESR characteristics is also in demand.

### SUMMARY

An aspect of the present disclosure may provide a tantalum capacitor capable of implementing low equivalent series resistance (ESR) characteristics in a high frequency band while having high capacitance.

According to an aspect of the present disclosure, a tantalum capacitor may include tantalum elements having protruding anode lead wires, a sealing part enclosing the tantalum elements, an insulating member disposed below the sealing part, an anode terminal electrically connected to the anode lead wires, and a cathode terminal electrically connected to the tantalum elements. At least two of the tantalum elements may be connected in parallel, and the cathode terminal may include a cathode terminal part disposed on a lower surface of the insulating member through a plurality of vias penetrating through the insulating member.

Here, the anode terminal may include an anode connection part connected to the anode lead wire, and an anode terminal part disposed on an edge of the lower surface of the insulating member to be spaced apart from the cathode terminal part.

The cathode terminal may be provided in singular or plural.

According to another aspect of the present disclosure, a tantalum capacitor may include a plurality of tantalum elements, a plurality of anode lead wires respectively led from the plurality of tantalum elements, a sealing part enclosing the plurality of tantalum elements and the plurality of anode lead wires to allow distal ends of the plurality of anode lead wires to be exposed, an insulating member disposed below the sealing part to correspond to the sealing part, a pair of anode terminals including anode connection parts connected to the plurality of anode lead wires and disposed on opposite side surfaces of the sealing part and anode terminal parts disposed on edges of a lower surface of the insulating member, and a cathode terminal including a cathode terminal part disposed on a central portion of the lower surface of the insulating member and a plurality of vias penetrating through the insulating member to electrically connect the plurality of tantalum elements to the cathode terminal part.

The plurality of tantalum elements may be connected in parallel.

The cathode terminal part may be provided in singular or plural.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a schematic perspective view of a tantalum capacitor according to an exemplary embodiment in the present disclosure;

FIG. 2 is a schematic plan view of FIG. 1;

FIG. 3 is a cross-sectional view taken along line I-I′ of FIG. 2;

FIG. 4 is a view illustrating a pair of anode terminals and a single cathode terminal of the tantalum capacitor of FIG. 3;

FIG. 5 is a cross-sectional view of a tantalum capacitor according to another exemplary embodiment in the present disclosure;

FIG. 6 is a view illustrating an example of anode terminals and separately disposed cathode terminals of the tantalum capacitor of FIG. 5; and

FIG. 7 is a view illustrating another example of anode terminals and separately disposed cathode terminals of the tantalum capacitor of FIG. 5.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

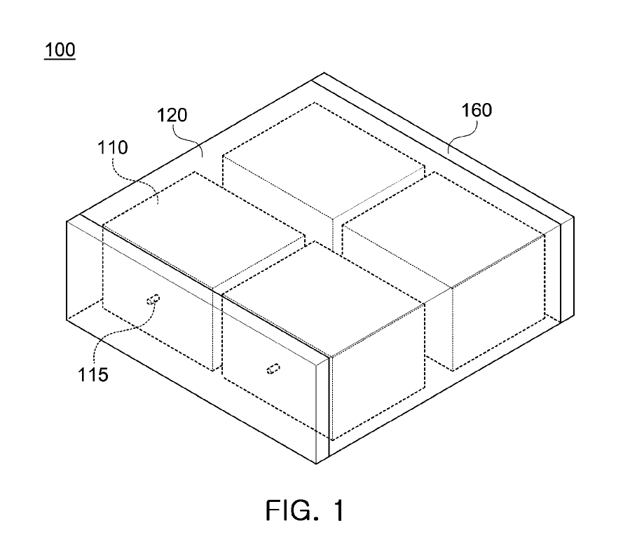

Hereinafter, a tantalum capacitor according to exemplary embodiments will be described in detail with reference to FIGS. 1 through 7.

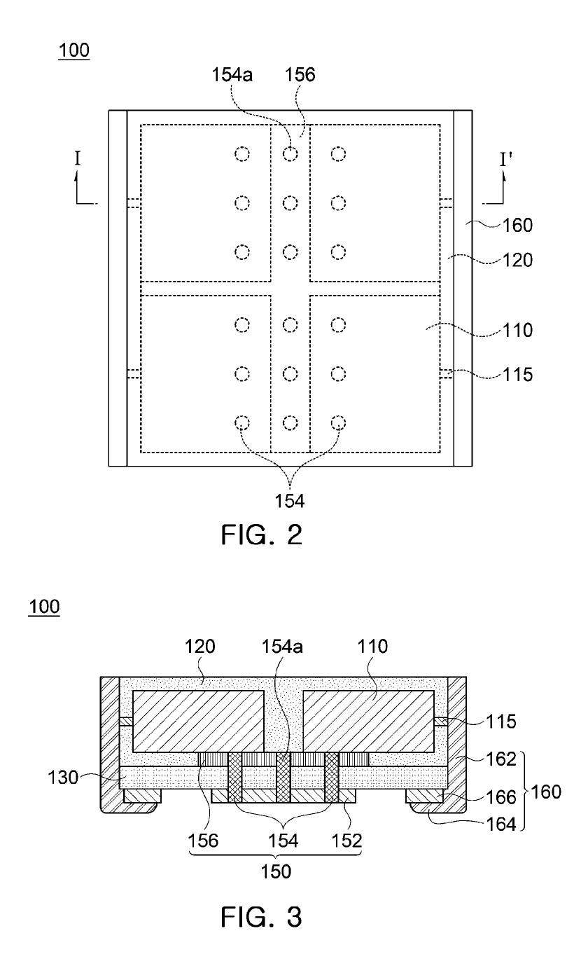

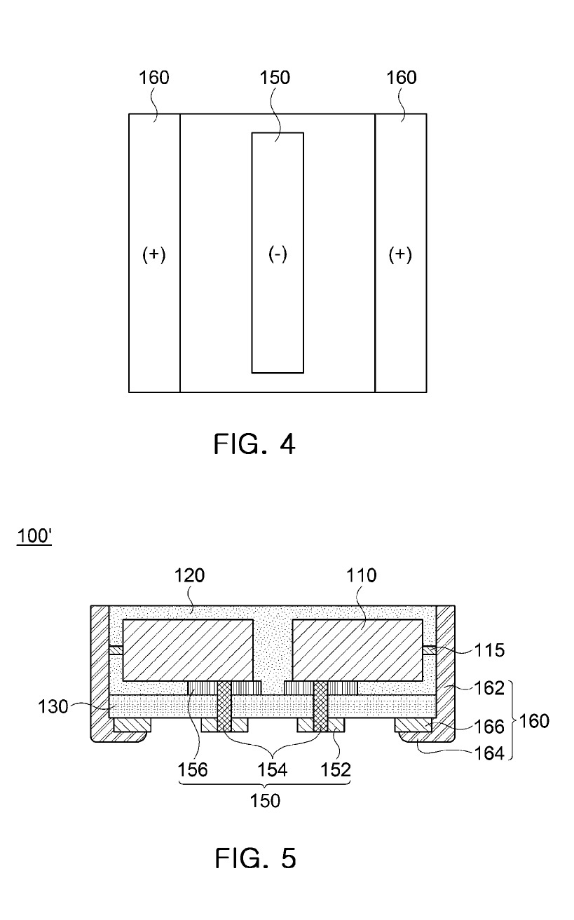

FIG. 1 is a schematic perspective view of a tantalum capacitor according to an exemplary embodiment, FIG. 2 is a schematic plan view of FIG. 1, FIG. 3 is a cross-sectional view taken along line I-I′ of FIG. 2, and FIG. 4 is a view illustrating a pair of anode terminals and a single cathode terminal of the tantalum capacitor of FIG. 3.

As illustrated in FIGS. 1 through 3, the tantalum capacitor 100 according to the present exemplary embodiment may include a plurality of tantalum elements 110, a plurality of anode lead wires 115 led from each of the plurality of tantalum elements 110, a sealing part 120 enclosing the plurality of tantalum elements 110 and the plurality of anode lead wires 115, an insulating member 130 formed below the sealing part 120, a cathode terminal 150 electrically connected to the plurality of tantalum elements 110 through a plurality of vias 154 provided in the insulating member 130, and a pair of anode terminals 160 connected to the plurality of anode lead wires 115.

The tantalum element 110, a sintered body formed by mixing and sintering tantalum powder, tantalum compound powder, or tantalum alloy powder, may have a negative polarity having high capacity per unit mass. The tantalum element 110 as described above may have a rectangular parallelepiped shape, but a shape of the tantalum element is not limited thereto.

According to the present exemplary embodiment, at least two tantalum elements 110 may be disposed in parallel with each other in two rows. Although four tantalum elements 110 disposed in two rows are illustrated in FIGS. 1 through 3, the number of tantalum elements 110 may be suitably adjusted depending on capacitance of a desired capacitor.

For example, a tantalum body constituting the tantalum element 110 may be manufactured by mixing and stirring tantalum powder and a binder at a predetermined ratio, compressing the mixed and stirred powder to form a rectangular parallelepiped, and then sintering the formed rectangular parallelepiped at a high temperature under a high vacuum atmosphere.

For example, the tantalum body of the tantalum element 110 may be manufactured by sealing tantalum powder mixed and stirred with the binder to have a desired size and then sintering the formed body at about 1,000° C. to 2,000° C. under a high vacuum atmosphere (10⁻⁵ torr or so) for about 30 minutes.

Conductive carbon (C) and silver (Ag) may be applied on a surface of the tantalum element 110. Here, conductive carbon is used to decrease contact resistance of the surface of the tantalum element 110, and silver (Ag) is used to lead the cathode.

The anode lead wire 115 may have a positive polarity. The anode lead wire 115 may be formed of a conductive metal material. For example, as the anode lead wire 115, a wire formed of the same tantalum material as that of the tantalum element 110 may be used, but a material of the anode lead wire 115 is not necessarily limited thereto.

The plurality of anode lead wires 115 may be led from a side surface of each of the plurality of tantalum elements 110 disposed in two rows in directions opposing each other. For example, among the plurality of tantalum elements 110 disposed in two rows, anode lead wires 115 of left tantalum elements 110 may be led to left side surfaces of the left tantalum elements 110, and anode lead wires 115 of right tantalum elements 110 may be led to right side surfaces of the right tantalum elements 110.

For instance, the anode lead wire 115 may be led from a side surface of the tantalum element 110 adjacent to an anode connection part 162 of the anode terminal 160 among the side surfaces of the tantalum element 110.

The anode lead wire 115 may be formed so that one front end portion thereof is embedded in one end portion of the tantalum element 110.

For example, the tantalum element 110 in which the anode lead wire 115 is embedded may be manufactured by inserting one front end portion of the anode lead wire 115 in a mixture of tantalum powder and the binder, sealing a tantalum element having a desired size, and sintering the formed body at a high temperature under a high vacuum atmosphere.

The sealing part 120 may enclose the plurality of tantalum elements 110 and the plurality of anode lead wires 115.

In this case, the sealing part 120 may be formed to expose distal ends of the plurality of anode lead wires 115 from the side surface of each of the plurality of tantalum elements 110 disposed in two rows in directions opposing each other.

The sealing part 120 may serve to protect the tantalum elements 110 and the anode lead wires 115 from external factors, and may be mainly formed of an epoxy or silica based epoxy sealing compound (EMC), or the like. However, a material of the sealing part 120 is not necessarily limited thereto, and other sealing materials known in the art may be used.

The insulating member 130 may be formed below the sealing part 120 to correspond to the sealing part 120. The insulating member 130 may be formed of glass fiber or a polymer based material having high insulation properties, a low shrinkage rate, and may have a sheet shape.

The insulating member 130 may serve to adjust a distance between the tantalum element 110 and cathode and anode terminal parts 152 and 164 and prevent electrical short circuits. In general, since insulation resistance of the tantalum element 110 is 10⁹Ω or more and a dielectric constant is 5.4 or less, in consideration of these properties, a thickness of the insulating member 130 may be 40 μm to 50 μm, but is not limited thereto.

A pair of anode terminals 160 may extend from opposite side surfaces of the sealing part 120 to edges of a lower surface of the insulating member 130, and may include the anode connection parts 162 and the anode terminal parts 164.

The anode terminal 160 may contain a conductive material, such as one of a chromium titanium intermetallic compound (Cr—Ti), copper (Cu), nickel (Ni), palladium (Pd), gold (Au), and a combination thereof, and may be formed by a sputter deposition method or a plating method.

The anode connection parts 162 may be portions of the anode terminals 160 formed on opposite side surfaces of the sealing part 120 and contact distal ends of the anode lead wires 115 exposed to opposite side surfaces of the sealing part 120 to thereby be electrically connected thereto.

The anode terminal parts 164 may be portions of the anode terminals 160 formed on edges of the lower surface of the insulating member 130. In this case, the anode terminal parts 164 may be used as connection terminals for electrical connection with an external circuit.

The anode terminal parts 164 as described above may be formed to cover 30% to 40% of the lower surface of the insulating member 130.

Here, when an area occupied by the anode terminal parts 164 is less than 30% of the lower surface of the insulating member 130, when the tantalum capacitor 100 is mounted in a product, a mounting area may be significantly small, and thus a defect rate of the product may be increased. Conversely, when the area occupied by the anode terminal parts 164 is more than 40% of the lower surface of the insulating member 130, an interval between the anode terminal 160 and the cathode terminal 150 may be significantly close, and when the tantalum capacitor 100 is mounted in the product, a short-circuit defect generation rate may be increased.

Meanwhile, the anode terminal 160 may further include an external electrode pattern 166 interposed between the edge portions of the lower surface of the insulating member 130 and the anode terminal part 164.

The external electrode pattern 166 may serve to complement conductivity of the anode terminal part 164 and compensate for a step with the cathode terminal 150.

The external electrode pattern 166 may contain a conductive material, such as one of a chromium titanium intermetallic compound (Cr—Ti), copper (Cu), nickel (Ni), palladium (Pd), gold (Au), and a combination thereof.

The cathode terminal 150 may be formed on a central portion of the lower surface of the insulating member 130 and include the cathode terminal part 152 and a plurality of vias 154.

The cathode terminal 150 may contain a conductive material, such as one of a chromium titanium intermetallic compound (Cr—Ti), copper (Cu), nickel (Ni), palladium (Pd), gold (Au), and a combination thereof, and may be formed by a sputter deposition method or plating method.

The cathode terminal part 152 of the cathode terminal 150 may be formed on the central portion of the lower surface of the insulating member 130 to be spaced apart from the anode terminal parts 164. In this case, the cathode terminal part 152 may be used as a connection terminal for electrical connection with an external circuit.

Here, an interval between the anode terminal part 164 and the cathode terminal part 152 on the lower surface of the insulating member 130 may be 200 μm to 400 μm, but the interval is not necessarily limited thereto.

A single cathode terminal part 152 may be formed in order to correspond to high capacitance. In this case, the plurality of tantalum elements 110 may be comprehensively connected to an external printed circuit board (PCB).

Among configurations of the cathode terminal 150, the via 154 may be provided to penetrate through the insulating member 130 and electrically connect each of the plurality of tantalum elements 110 to the cathode terminal part 152. The via 154 may be formed to penetrate up through the cathode terminal part 152.

The via 154 may correspond one-to-one to each of the tantalum elements 110. Alternatively, a plurality of vias 154 may correspond to each of the tantalum elements 110. For instance, the number of vias 154 corresponding to each of the tantalum elements 110 may be freely changed depending on a design. A case in which the plurality of vias 154 are formed in each of the tantalum elements 110 is illustrated in FIG. 2.

Meanwhile, the cathode terminal 150 may further include a single internal electrode pattern 156 interposed between the plurality of tantalum elements 110 and the insulating member 130 and including the plurality of vias 154 provided therein to be connected to the tantalum elements 110.

The internal electrode pattern 156 may contain a conductive material, such as one of a chromium titanium intermetallic compound (Cr—Ti), copper (Cu), nickel (Ni), palladium (Pd), gold (Au), and a combination thereof.

The internal electrode pattern 156 may increase a contact area with the tantalum elements 110 to increase a current path, a path through which current passes, thereby decreasing equivalent series resistance (ESR).

Due to the configuration as described above, in the tantalum capacitor 100 according to the present exemplary embodiment, two anode terminals 160 are disposed on opposite sides of the tantalum capacitor 100, and a single cathode terminal 150 is disposed between the two anode terminals 160 as illustrated in FIG. 4, and thus the tantalum capacitor may have a three-terminal structure in which the anode (+), the cathode (−), and the anode (+) are sequentially arranged.

Generally, in order to decrease equivalent series inductance (ESL), parasitic inductance on a circuit of a capacitor, it is more advantageous for the current loop, a distance between the anode terminal 160 and the cathode terminal 150, to be shorter. Further, in a case of connecting terminals so that polarities thereof are disposed in a sequence of positive/negative/positive, or negative/positive/negative, inductance may be formed therebetween such that ESL may be more effectively reduced.

Since the tantalum capacitor 100 according to the present exemplary embodiment has a structure in which the cathode is led to a lower portion of the tantalum element 110 through the via 154, and thus, the current loop may be decreased due to a decrease in the distance between the anode terminal part 164 and the cathode terminal part 152, ESL may be decreased.

Further, in the tantalum capacitor 100 according to the present exemplary embodiment, since the cathode terminal 150 and the anode terminals 160 has a connection configuration of positive/negative/positive, ESL may be further decreased.

Meanwhile, a dummy via 154a penetrating through the insulating member 130 to thereby be electrically connected to the cathode terminal part 152 may be further provided between the plurality of tantalum elements 110 corresponding to the cathode terminal part 152. The dummy via 154a may be formed to penetrate up through the cathode terminal part 152.

The dummy via 154a as described above may increase the current path, thereby decreasing ESR.

The vias 154 and the dummy via 154a as described above may be formed by providing a conductive material in via holes (not illustrated) penetrating through the insulating member 130 or penetrating through the insulating member 130 and the cathode terminal part 152 in a thickness direction.

In the tantalum capacitor 100 according to the present exemplary embodiment as described above having the three-terminal structure in which there is no frame, the plurality of tantalum elements 110 may be connected in parallel, and thus the tantalum capacitor may implement low ESR characteristics in a high frequency band of 100 kHz or more while having high capacitance. This fact may be confirmed through the following Equations 1 and 2.

$$\begin{matrix}{R}_{Total} = {R}_{a} + {R}_{b} & [ Equation 1 ] \\ {R}_{Total} = \frac{1}{\frac{1}{{R}_{a}} + \frac{1}{{R}_{b}}} = \frac{{R}_{a} {R}_{b}}{{R}_{a} + {R}_{b}} & [ Equation 2 ]\end{matrix}$$

For instance, an ESR value by two tantalum elements having resistance of Rₐ and R_{b} connected in parallel may theoretically be half that of a single tantalum element if Rₐ is equal to R_{b}, which may have an influence on impedance determining ESL, thereby serving to decrease ESL.

Further, in the tantalum capacitor 100 according to the present exemplary embodiment, the distance between the anode terminal part 164 and the cathode terminal part 152 may be significantly decreased, the terminals 150 and 160 may be disposed in a sequence of the anode (+)/the cathode (−)/the anode (+), and at the same time, an internal resistance element may be significantly decreased by forming the internal electrode pattern 156, the dummy via 154a, and the like, whereby an effect of decreasing ESL may be significantly increased in a high frequency band.

As a result, the tantalum capacitor 100 according to the present exemplary embodiment may implement low ESR and low ESL in a high frequency band while having high capacitance.

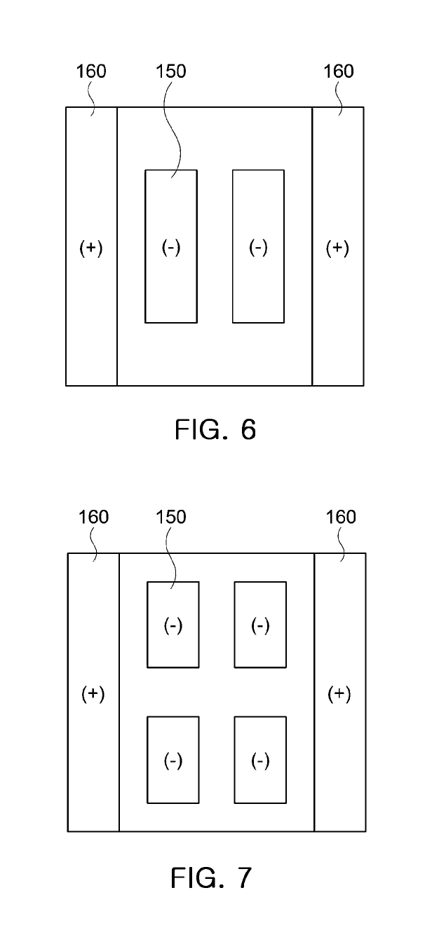

Meanwhile, FIG. 5 is a cross-sectional view of a tantalum capacitor according to another exemplary embodiment, FIG. 6 is a view illustrating an example of anode terminals and separately disposed cathode terminals of the tantalum capacitor of FIG. 5; and FIG. 7 is a view illustrating another example of anode terminals and separately disposed cathode terminals of the tantalum capacitor of FIG. 5.

The same components in the exemplary embodiment of FIG. 5 as those in the exemplary embodiment of FIG. 3 are denoted by the same reference numerals, an overlapping description of the same components will be omitted, and only differences will be described.

For instance, other configurations of the exemplary embodiment illustrated in FIG. 5 are the same as those in the exemplary embodiment illustrated in FIG. 3 except that a plurality of cathode terminal parts 152 and a plurality of internal electrode patterns 156 are applied.

As illustrated in FIGS. 6 and 7, the tantalum capacitor has a three-terminal structure in which an anode (+), a cathode (−), and an anode (+) are arranged, which is the same structure as in the exemplary embodiment of FIG. 3 except that a plurality of cathode terminals 150 may be separately disposed between the anode terminals 160 due to the plurality of cathode terminal parts 152.

Therefore, in the tantalum capacitor 100′ according to the exemplary embodiment of FIG. 5, the desired number of tantalum elements 110 may be independently connected to an external PCB through each of the cathode terminal parts 152 depending on the desired capacitance.

In this case, the plurality of tantalum elements 110 are connected in parallel, a distance between and the anode terminal part 164 and the cathode terminal part 152 may be significantly decreased, and an internal resistance element may be significantly decreased by forming the internal electrode pattern 156, a dummy via (not illustrated), and the like, and thus the tantalum capacitor 100′ may implement low ESR and low ESL in a high frequency band while having high capacitance.

As set forth above, according to exemplary embodiments, the plurality of tantalum elements connected in parallel and the distance between the anode terminal part and the cathode terminal part may be significantly decreased, and thus the tantalum capacitor may implement low ESR and low ESL in a high frequency band while having high capacitance.

Further, in the tantalum capacitor according to the exemplary embodiments, the internal resistance element may be significantly decreased by forming the internal electrode pattern, the dummy via, and the like, and thus the tantalum capacitor may implement lower ESR and lower ESL.

In addition, in the tantalum capacitor according to the exemplary embodiments, the cathode terminal part may be formed in singular or plural, and thus the tantalum elements may be comprehensively or independently connected to an external PCB depending on the desired capacitance.

While exemplary embodiments have been shown and described above, it will be apparent to those skilled in the art that modifications and variations could be made without departing from the scope of the present invention as defined by the appended claims.

What is claimed is:

1. A tantalum capacitor comprising:
a plurality of tantalum elements;
a plurality of anode lead wires respectively led from the plurality of tantalum elements;
a sealing part enclosing the plurality of tantalum elements and the plurality of anode lead wires to allow distal ends of the plurality of anode lead wires to be exposed;
an insulating member disposed below the sealing part to correspond to the sealing part;
a pair of anode terminals including anode connection parts connected to the plurality of anode lead wires and disposed on opposite side surfaces of the sealing part and anode terminal parts disposed on edges of a lower surface of the insulating member; and
a cathode terminal including a cathode terminal part disposed on a central portion of the lower surface of the insulating member and a plurality of vias penetrating through the insulating member to electrically connect the plurality of tantalum elements to the cathode terminal part.

2. The tantalum capacitor of claim 1, wherein the plurality of tantalum elements are connected in parallel.

3. The tantalum capacitor of claim 1, wherein the cathode terminal part is provided in singular or plural.

4. The tantalum capacitor of claim 1, wherein the plurality of vias penetrate up through the cathode terminal part.

5. The tantalum capacitor of claim 1, wherein the cathode terminal further comprises an internal electrode pattern interposed between the plurality of tantalum elements and the insulating member and including the plurality of vias connected to the plurality of tantalum elements.

6. The tantalum capacitor of claim 5, wherein the internal electrode pattern is provided in singular or plural.

7. The tantalum capacitor of claim 1, wherein the anode terminals further comprise external electrode patterns interposed between the edges of the lower surface of the insulating member and the anode terminal parts.

8. The tantalum capacitor of claim 1, further comprising a dummy via penetrating through the insulating member between the plurality of tantalum elements corresponding to the cathode terminal.

9. The tantalum capacitor of claim 8, wherein the dummy via penetrate up through the cathode terminal part.

10. The tantalum capacitor of claim 1, wherein each of the plurality of anode lead wires is led from a side surface of the tantalum element adjacent to the anode connection part among the side surfaces thereof to thereby electrically connect to the anode connection part.

11. A tantalum capacitor comprising tantalum elements having protruding anode lead wires, a sealing part enclosing the tantalum elements, an insulating member disposed below the sealing part, an anode terminal electrically connected to the anode lead wires, and a cathode terminal electrically connected to the tantalum elements,
wherein at least two of the tantalum elements are connected in parallel, and
the cathode terminal includes a cathode terminal part disposed on a lower surface of the insulating member through a plurality of vias penetrating through the insulating member.

12. The tantalum capacitor of claim 11, wherein the anode terminal comprises:
an anode connection part connected to the anode lead wire; and
an anode terminal part disposed on an edge of the lower surface of the insulating member to be spaced apart from the cathode terminal part.

13. The tantalum capacitor of claim 11, wherein the cathode terminal is provided in singular or plural.

14. The tantalum capacitor of claim 11, wherein the cathode terminal is disposed on a central portion of the lower surface of the insulating member.
